(19) United States
(12) Patent Application Publication
(10) Pub. No.: US 2015/0347611 A1
(43) Pub. Date: Dec. 3, 2015

(54) PORTAL CONTEXT SWITCHING FOR HIERARCHICAL RESALE OF TELECOMMUNICATION PRODUCTS

(71) Applicant: GENBAND US LLC, Frisco, TX (US)

(72) Inventor: Trevor Holt, Ottawa (CA)

(73) Assignee: GENBAND US LLC, Frisco, TX (US)

(21) Appl. No.: 14/295,118

(22) Filed: Jun. 3, 2014

(51) Int. Cl. G06F 17/30; G06Q 30/06; H04L 29/08

(52) U.S. Cl. CPC G06F 17/30896; G06F 17/30905; H04L 67/02; G06Q 30/0641

(57) ABSTRACT

Systems and methods for portal context switching for hierarchical resale of telecommunication products are presented. In some embodiments, a method may include making available, via one or more computer systems, a plurality of portal instances having a hierarchical structure of resellers and customers of communication services, each of the plurality of portal instances having a plurality of users, each of the plurality of users associated with a corresponding one of a plurality of different access levels, a given access level configured to determine a feature that is visible to a given user through a given portal instance. The method may also include allowing the given user to query or enact a change to the given portal instance via a web client using an Application Programming Interface (API) call, wherein the API call includes an API key and a user identifier.

### TECHNICAL FIELD

This disclosure relates generally to telecommunications, and more specifically, to portal context switching for hierarchical resale of telecommunication products.

### BACKGROUND

The following discussion sets forth the inventors' own knowledge of certain technologies and/or problems associated therewith. Accordingly, this discussion is not an admission of prior art, and it is not an admission of the knowledge available to a person of ordinary skill in the art.

The telecommunication industry continues to grow rapidly, but is becoming increasingly competitive. Most telecommunication companies rely upon a direct sales business model in which the provider advertises and markets telecommunication products directly to end-users. Some providers target enterprise customers for bulk purchases of services for enterprise use, but the enterprise and its employees are still the end user of the services. This business model generally requires expensive advertising campaigns and costly employment of direct sales professionals.

### SUMMARY

Systems and methods for portal context switching for hierarchical resale of telecommunication products are presented. In an illustrative, non-limiting embodiment, a method may include making available, via one or more computer systems, a plurality of portal instances having a hierarchical structure of resellers and customers of communication services, each of the plurality of portal instances having a plurality of users, each of the plurality of users associated with a corresponding one of a plurality of different access levels, a given access level configured to determine a feature that is visible to a given user through a given portal instance. The method may also include allowing the given user to query or enact a change to the given portal instance via a web client using an Application Programming Interface (API) call, wherein the API call includes an API key and a user identifier.

In some cases, the API key and the user identifier may both point to the given user, and the given portal instance may be associated with a reseller or customer organization to which the given user belongs. Alternatively, the API key may point to the given user, the user identifier may point to another user, the given user may belong to a first organization, and the other user may belong to a second organization that is lower in the hierarchical structure than the first organization. For example, the second organization may be a customer of the first organization.

The method may include identifying a masquerading attempt on the part of the given user based, at least in part, upon the API key and the user identifier pointing to different users. The method may also include stopping the given user from assuming an identity of the other user in response to the API key not indicating a masquerading privilege. The method may further include allowing the given user to assume an identity of the other user in response to the API key indicating a masquerading privilege.

The method may include making a given feature visible to the given user through the given portal instance, wherein the given feature would otherwise be visible only to yet another user belonging to the same organization as the other user. The method may also include logging one or more actions or events caused by the given user using an identity of the given user derived from the API key.

In another illustrative, non-limiting embodiment, a tangible computer-readable storage medium may have program instructions stored thereon that, upon execution by a computer system, cause the computer system to: receive an API call from a user, wherein the API call includes at least two distinct user identifiers; and provide at least one portion of a portal instance to the user in response to the API call, wherein the portal instance is one of a plurality of portal instances associated with different organizations arranged in a hierarchical structure.

The at least two distinct user identifiers may include a key and an identity. For instance, the key may point to the user, the identity may point to another user, the user may belong to a first organization, and the other user may belong to a second organization that is lower in the hierarchical structure than the first organization. The second organization may be a customer of the first organization.

In some cases, the program instructions, upon execution by the computer system, may cause the computer system to identify a masquerading attempt on the part of the user and/or may cause the computer system to allow the user to assume an identity of the other user. The at least one portion of a portal instance provided to the user may be ordinarily provided to the other user and it may include one or more features associated with the second organization.

In yet another illustrative, non-limiting embodiment, a computer system may include a processor and a memory coupled to the processor, the memory including program instructions stored thereon that, upon execution by the computer system, cause the computer system to: receive a command from a user to query or enact a change to at least one portion of a portal instance hosted by a server, wherein the portal instance is one of a plurality of portal instances associated with different organizations arranged in a hierarchical structure; transmit an API call to the server, wherein the API call includes an API key and a user identifier; and receive a response to the API call from the server.

The API key may point to the user, the user identifier may point to another user, the user may belong to a first organization, and the other user may belong to a second organization that is lower in the hierarchical structure than the first organization. The server may be configured to allow the user to assume an identity of the other user in response to the API key indicating masquerading privileges. Also, the program instructions, upon execution by the computer system, may further cause the computer system to render an aspect of the response to the user, wherein the aspect includes a visual feature associated with the second organization and not associated with the first organization.

### BRIEF DESCRIPTION OF THE DRAWINGS

Reference will now be made to the accompanying drawings, wherein:

FIG. 1 is a block diagram illustrating an example of a system configured to implement a hierarchical resale of telecommunication products according to some embodiments.

FIG. 2 is a block diagram illustrating an example of another system configured to implement the hierarchical resale of telecommunication products according to some embodiments.

FIG. 3 is a block diagram illustrating an example of yet another system configured to implement the hierarchical resale of telecommunication products according to some embodiments.

FIG. 4 is a block diagram illustrating an example of a computer network configured to implement the hierarchical resale of telecommunication products according to some embodiments.

FIG. 5 is a block diagram illustrating an example of a computer system configured to implement portal context switching for hierarchical resale of telecommunication products according to some embodiments.

FIG. 6 is a block diagram illustrating an example of portal application instruction modules configured to implement portal context switching for hierarchical resale of telecommunication products according to some embodiments.

FIG. 7 is a flowchart illustrating an example of a method for hierarchical resale of telecommunication products according to some embodiments.

FIG. 8 is a flowchart illustrating another example of a method for hierarchical resale of telecommunication products according to some embodiments.

FIG. 9 is a flowchart illustrating an example of yet another method for hierarchical resale of telecommunication products according to some embodiments.

FIG. 10 is a screenshot illustrating an example of a reseller's portal instance according to some embodiments.

FIG. 11 is a screenshot illustrating an example of a customer's portal instance according to some embodiments.

FIG. 12 is a flowchart illustrating an example of a method for portal context switching and user masquerading according to some embodiments.

### DETAILED DESCRIPTION

Embodiments disclosed herein are directed generally to portal context switching for hierarchical resale of telecommunication products. In an embodiment, a hierarchical resale system may allow a provider to leverage a hierarchical resale business model for sale of telecommunication products. In a hierarchical resale business model, the provider may make telecommunication products available to a business partner for resale to lower level business partners, or directly to end users. For example, a provider of communication services may allow a partner or reseller to purchase services and/or products for resale to an enterprise or individual customer.

The terms “telecommunication product,” “communication product,” “product,” “telecommunication service,” “communication service,” and “service” may be used interchangeably herein to mean telecommunication equipment and goods (e.g., physical devices such as routers, switches, gateways, etc.), services (e.g., VoIP line, voicemail, mobile service, etc.), and/or associated add-on features or services (e.g., warranties, replacement plans, insurance, support contracts, etc.). In an embodiment, a product may be mapped to provisionable services across one or more back end systems, or to physical services/warranties, etc., which may exist outside the scope of the portal's ability to enact.

The purchaser may directly use the services/products, or may sell the services to lower level customers. At each level of the hierarchy, the resellers may markup the cost of the services provided to its customers to derive an incremental profit on the sale. In an embodiment, the reseller may offer products which embody services from the level above as well as products created by the reseller directly. In such an embodiment, products may be bundled within each group or across groups. There may be a one-to-one relationship between products at the reseller level and the item from which it is derived provided by the level above, in some embodiments. Higher ratio bundling is also possible as well as bundling IP and non-IP services at the same level. In other embodiments, the resellers may bundle the communication services in custom-defined service bundles for resale. In still a further embodiment, resellers may bundle their own products along with the communication services. For example, the resellers may provide support services in addition to the communication services.

As a person of ordinary skill will recognize in light of this disclosure, however, other embodiments are not necessarily limited to provisioning of communication services, but may be extended to other forms of communication services, including standard telephone services, mobile communication services, screen sharing, messaging, and the like.

In order to facilitate the hierarchical resale model, embodiments described herein provide systems, methods, and computer operations for implementing a hierarchical portal application. In a particular embodiment, a portal application may be hosted by the communication provider and made available to service resale partners to facilitate implementation of the hierarchical resale model. In a further embodiment, the portal application may also be made available to lower level customers and/or end users. Certain embodiments provide methods for rebranding the portal, sometimes referred to as “white labeling” the portal, to give the reseller a customized or rebranded virtual store front for resale of the communication services to lower-level customers. By default, a “child” level in the hierarchy may inherit the branding of the “parent” level in the hierarchy. In some embodiments, resellers and, if permitted by the reseller, customers can choose to override this branding of their instance of the portal. Additionally, the portal and associated background functions may automate certain functions associated with purchasing, provisioning, billing, communicating action acknowledgments, etc.

Beneficially, the aforementioned embodiment may facilitate implementation of a hierarchical business model for sale and resale of telecommunication products. Each reseller in the hierarchy may be provided with a customizable and individualized storefront, which can be branded for use with its employees and customers. Many of the functions associated with ordering, fulfillment and activation of the telecommunication products may be automated, further streamlining the business model. This streamline business model may reduce overhead and advertising costs to the communication provider. Additionally, business processes associated with purchasing, provisioning, billing and the like may be automated for the reseller, which may reduce overhead costs and improved profit margins accordingly.

In some embodiments, a hierarchical-based portal may support context switching whereby a user with appropriate permissions is capable of switching the context of the portal from that of their own company to that of a customer, for example, to facilitate the ability for a reseller to easily manage services on behalf of their customers. As described in more detail below, context switching functionality when combined with granular permissions controls, may provide resellers with a wide variety of business models under which they may operate (i.e., they can manage all functions of their customers, none of those functions, or any selected number of specific functions).

The term “telecommunications,” as used herein, is intended to encompass voice communications or telephony, as well as other forms of communications (e.g., video communications, videoconferencing, instant messaging or IM, Short Messaging Service or SMS, emails, etc.) that may take place electronically, for example, over wireless networks, circuit-switched networks, packet-switched networks, Application Program Interfaces (APIs) or any combination thereof.

The term “enterprise,” as used herein, means a company or organization, including, but not limited to, global corporations, small to medium sized businesses (SMBs), universities, non-profit organizations, etc.

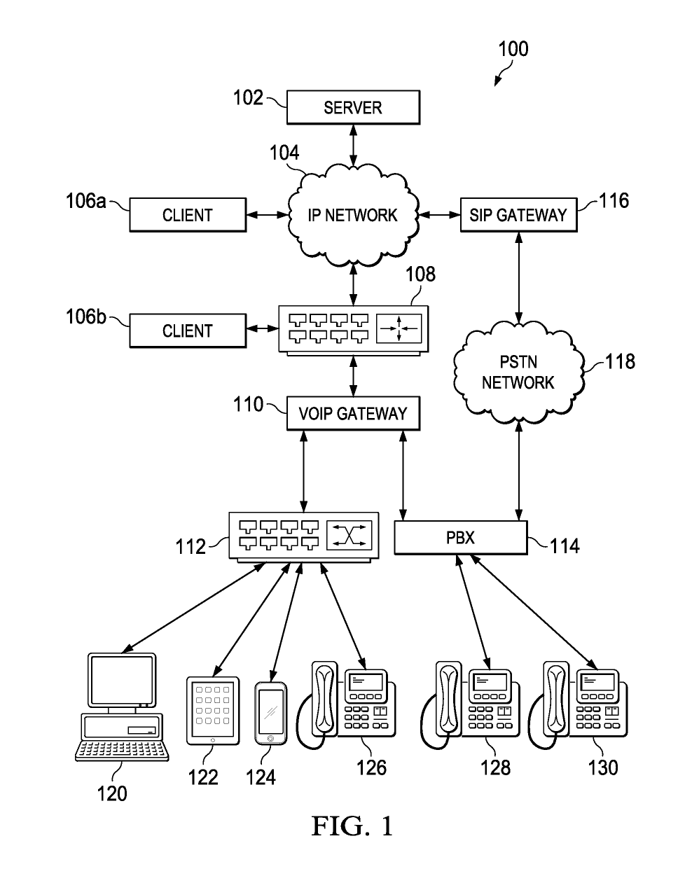

FIG. 1 is a block diagram illustrating an example of system 100 configured to implement a hierarchical resale of telecommunication products. The embodiment of FIG. 1 illustrates an example in which a provider provides access to telecommunication resources to an enterprise customer. The telecommunication products may be provided to the enterprise customer directly in some embodiments. Alternatively, a reseller of the telecommunication products may provide the telecommunication products.

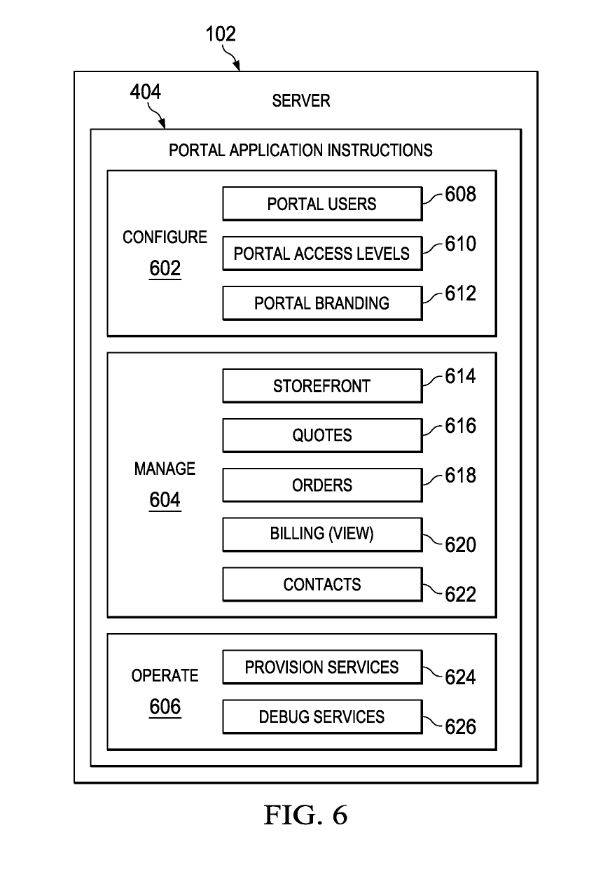

In an embodiment, system 100 includes IP network 104 configured to provide telecommunication products. Telecommunication products may include data communications, Voice over IP (VoIP) telephone services, videophone services, messaging, or the like. In an embodiment, system 100 includes server 102 and one or more clients 106a,b configured to communicate with server 102 via IP network 104, or any other suitable network. As described below with reference to FIGS. 4 and 6, server 102 may host a portal application for facilitating management of sale, activation, and subsequent billing for the use of the telecommunication products.

In an embodiment, client 106a may load a version of the portal application hosted by server 102. For example, client 106a may download a web-based portal application from server 102. A telecommunication service reseller may operate client 106a. The enterprise customer may operate client 106b. In an embodiment, the version of the portal application viewed by the enterprise customer on client 106b may be a rebranded version of the original application hosted on server 102. For example, the reseller may change the colors, logos, and other information on the portal application using client 106a, and the rebranded application may be displayed to the enterprise customer on client 106b.

In an embodiment, one or more routers 108 may couple the enterprise local network to IP network 104. Additionally, router 108 may couple client 106b to the IP network 104, and facilitate communication between client 106b and server 102. Additionally, VoIP gateway 110 may be coupled to router 108. VoIP gateway 110 may be configured to provide telephone access to IP network 104 via router 108. In a further embodiment, network traffic switching device 112 may be coupled to VoIP gateway 110, and configured to provide access between VoIP gateway 110 and multiple user interface devices.

Examples of user interface devices include computer workstation 120 configured with a soft phone application, tablet device 122 configured with telephone capabilities, smartphone 124 configured to communicate via IP network 104 according to a VoIP protocol, and/or telephone 126.

In an embodiment, the enterprise local network may include Private Branch Exchange (PBX) 114. One or more telephones 128 may be coupled to PBX 114. PBX 114 may be connected to VoIP gateway 110, either directly or through switch 112. In addition, PBX may be coupled to a Public Switched Telephone Network (PSTN) 118 for providing PSTN telephone services. In an embodiment, devices on IP network 104 may also communicate via PSTN 118 by connecting through Session Initiation Protocol (SIP) gateway 116, or the like.

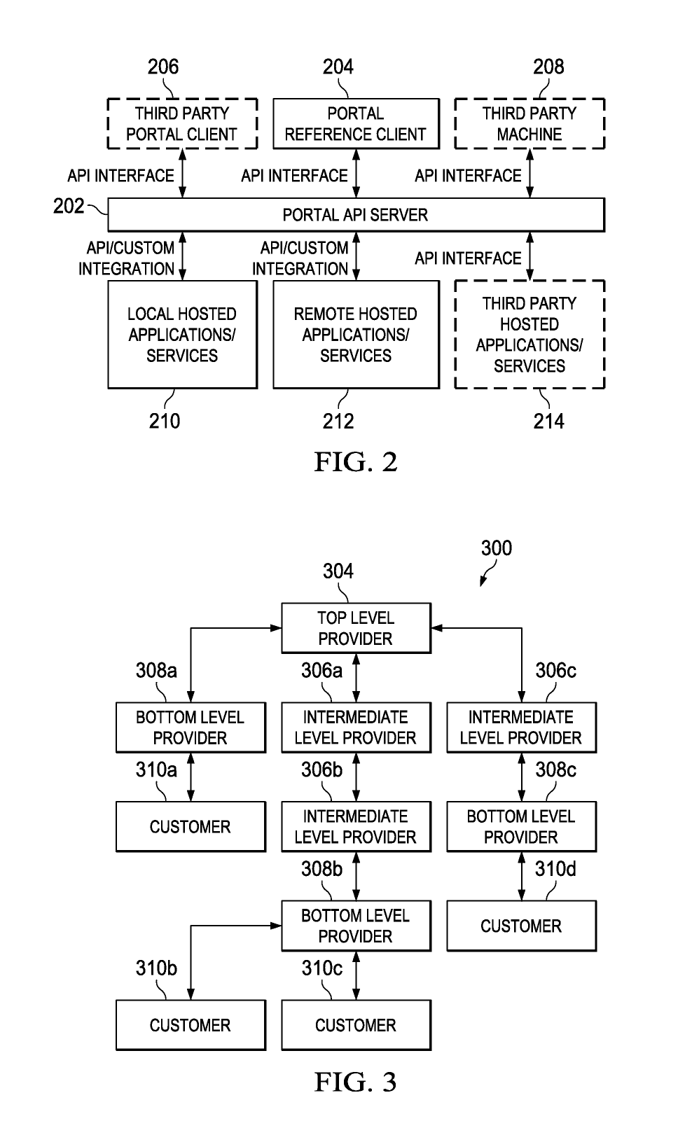

FIG. 2 illustrates an embodiment of system 200, in which functions of the portal application are accessible via portal Application Program Interface (API) server 202. Portal API server 202 may provide access to one or more APIs for use of portal application functionality within a reseller's native software. For example, API interfaces may be provided to portal reference client 204, third party portal client 206, third party machine 208, etc. Additionally, API interfaces or custom integration may be included with locally hosted applications or services 210, remote hosted applications or services 212, or third party hosted applications or services 214. In an embodiment, the API user interface (UI) may be rendered as a web page, complete with HTML, CSS, images and/or JavaScript available via any browser. In a further embodiment, client-specific functions such as customized color schemes and logos, may be made available via the API.

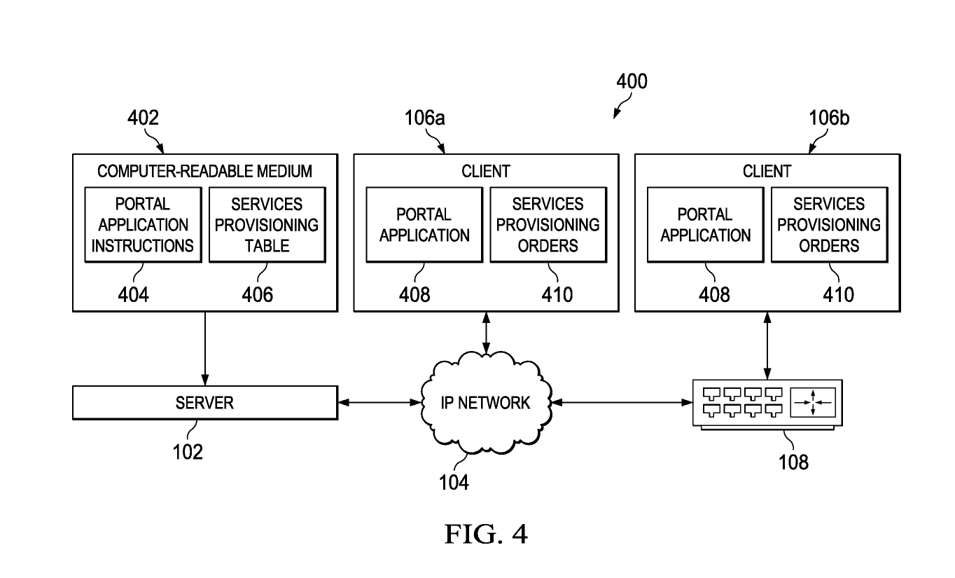

FIG. 3 is a block diagram illustrating an example of yet another system 300 configured to implement the hierarchical resale of telecommunication products. In an embodiment, system 300 may include a carrier network, and communication providers may provide access to the carrier network and other associated services to communication services customers. For example, top level communication provider 304 may manage provisioning of access to the carrier network. In an embodiment, top level communication provider 304 may additionally manage and maintain servers 102 which may be used to host the portal application and facilitate provisioning of access between communication services customer 310b and carrier network 302. In an embodiment, carrier network 302 may be IP network 104. One of ordinary skill will recognize, however, that carrier network 302 may include any one of a variety of communication network types, such as a mobile communication network, and is not limited to the embodiments discussed with relation to FIG. 1.

According to the hierarchical structure, top level communication provider 304 may allow one or more partners or resellers to resell the communication services. For example, top level communication provider 304 may provide communication services to bottom level communication provider 308a, intermediate level communication provider 306a, and/or intermediate level communication provider 306c. In other embodiments, top level communication provider 304 may also provide access directly to a communication services customer.

Additionally or alternatively, bottom level communication provider 308a may provide access to communication services customer 310a. Intermediate level communication provider 306c may provide communication services to communication services customer 310d via bottom level communication provider 308c. Similarly, intermediate level communication provider 306a may resell services to intermediate level communication provider 306b, who may further resell to bottom level communication provider 308b. Bottom level communication provider 308b may additionally resell services to both communication services customers 310b-c. As a person of ordinary skill will recognize in light of this disclosure, a variety of hierarchical structures may be used, which may be driven by partner relationships to the top level communication provider 304 and/or customer relationships.

In an example, top level provider 304 may be a provider of VoIP telephone equipment, software, and services. Bottom level provider 308a may be a reseller of VoIP gateway equipment, and customer 310a may be a company that purchases the VoIP gateway for an IP telephone network. Intermediate level provider 306a may be a reseller of VoIP services. Intermediate provider 306a may resell the services to a second intermediate provider 306b, who may further sell the services to a bottom level provider 306b. Bottom level provider 308b may sell the services to residential customer 310b and/or to enterprise customer 310c. Intermediate provider 306d may resell VoIP software, such as softphones to bottom level provider 308b. Bottom level provider 308d may sell, or otherwise provide the softphone software to its customers 310d. For example, bottom level provider 308b may be a university, and may distribute the softphone application to its students as part of a campus communication system.

FIG. 4 is a block diagram illustrating an example of computer network 400 configured to implement the hierarchical resale of telecommunication products. In an embodiment, server 102 may be in communication with tangible, non-transitory computer-readable medium 402. For example, computer-readable medium 402 may be a hard disk or memory device that is internal to the server 102. Additionally or alternatively, computer-readable medium 402 may be a hard disk or memory device that is external to server 102, but with which server 102 is configured to communicate. In another embodiment, computer-readable medium 402 may be a removable medium such as an optical storage disk, a removable flash memory device, etc.

In an embodiment, computer-readable medium 402 may include software or computer code which, when loaded in to server 102, cause components of server 102, including the server's processor to operate as special purpose devices according to the instructions provided. In an embodiment, the instructions may include instructions for causing the server to host, manage, or operate portal application 404 for sale and resale of communication services. Additionally, computer-readable medium 402 may include a services provisioning table 406 comprising information regarding the services on carrier network 302 that have been provisioned for communication services customers 310a-d, for example.

In an embodiment, server 102 may be managed or operated by top level communication provider 304. Additionally, client 106a may be operated by bottom level communication provider 308a. In such an embodiment, client 106b may be operated by communication services customer 310a. Alternatively, client 106a may be operated by an intermediate communication provider 306a-c, and client 106b may be operated by a lower level communication provider 308b-c, or by a communication services customer 310b-d.

Each client 106a-b may additionally load a portal application 408. For example, in an embodiment, portal application 408 may be a web application downloaded from server 102. Portal application 408 may comprise all or a portion of portal application instructions 404. Additionally, each client 106a-b may generate one or more services provisioning orders 410 for requesting access to services associated with carrier network 302.

In an example, server 102 may be operated by top level communication provider 304, and may host portal application instructions 404 as well as maintain services provisioning table 406. Bottom level communication provider 308a may contract with top level communication provider 304 to resell communication services under its own brand. Bottom level communication provider 308a may use client 106a to access portal application 408, which is configured to communicate with server 102. Bottom level communication provider 106a may sell communication services to communication services customer 310a. Communication services customer 310a may access portal application 408 using client 106b. Communication services customer 310a may use portal application 408 to submit a services provisioning order 410 to bottom level communication provider 308a. In an embodiment, bottom level communication provider 308a may forward the services provisioning order 410 to server 102 via client 106a. Upon receipt, server 102 may update services provisioning table 406 to reflect the services provisioning order 410. In an alternative embodiment, client 106b may communicate services provisioning orders 410 directly to server 102, and server 102 may communicate information related to the services provisioning orders 410 to bottom level provider 308a at client 106a.

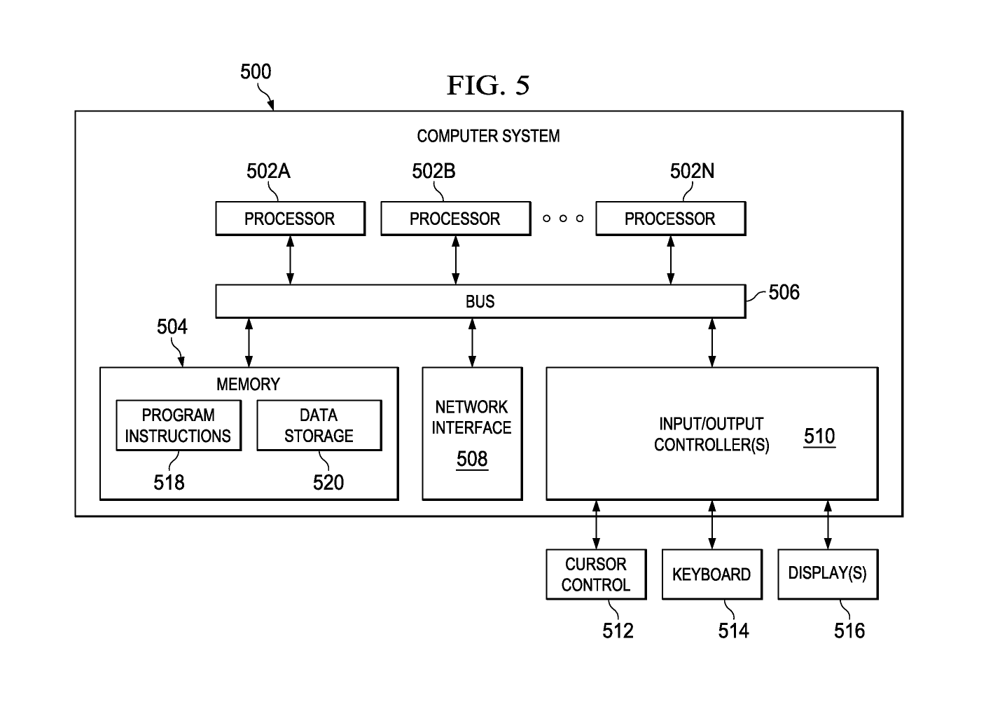

FIG. 5 is a block diagram illustrating an example of a computer system configured to implement portal context switching for hierarchical resale of telecommunication products. In an embodiment, server 102 may be implemented on a computer system similar to the computer system 500 described in FIG. 5. In various embodiments, server 500, or any server referred to herein, may be a physical server or a virtualized (i.e., cloud) based instance of a server. Similarly, client 106a may be implemented on a computer system similar to the computer system 500 described in FIG. 5. Client 106b may also be implemented on a computer system similar to the computer system 500. In various embodiments, computer system 500 may be a server, a mainframe computer system, a workstation, a network computer, a desktop computer, a laptop, or the like.

As illustrated, computer system 500 includes one or more processors 502A-N coupled to a system memory 504 via bus 506. Computer system 500 further includes network interface 508 coupled to bus 506, and input/output (I/O) controller(s) 510, coupled to devices such as cursor control device 512, keyboard 514, and display(s) 516. In some embodiments, a given entity (e.g., server 102) may be implemented using a single instance of computer system 500, while in other embodiments multiple such systems, or multiple nodes making up computer system 500, may be configured to host different portions or instances of embodiments (e.g., clients 106a, b).

In various embodiments, computer system 500 may be a single-processor system including one processor 502A, or a multi-processor system including two or more processors 502A-N (e.g., two, four, eight, or another suitable number). Processor(s) 502A-N may be any processor capable of executing program instructions. For example, in various embodiments, processor(s) 502A-N may be general-purpose or embedded processors implementing any of a variety of instruction set architectures (ISAs), such as the x86, POWERPC®, ARMO, SPARC®, or MIPS® ISAs, or any other suitable ISA. In multi-processor systems, each of processor(s) 502A-N may commonly, but not necessarily, implement the same ISA. Also, in some embodiments, at least one processor(s) 502A-N may be a graphics processing unit (GPU) or other dedicated graphics-rendering device.

System memory 504 may be configured to store program instructions and/or data accessible by processor(s) 502A-N. For example, memory 504 may be used to store software program and/or database shown in FIGS. 6-8. In various embodiments, system memory 504 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 504 as program instructions 518 and data storage 520, respectively. In other embodiments, program instructions and/or data may be received, sent or stored upon different types of computer-accessible media or on similar media separate from system memory 504 or computer system 500. Generally speaking, a computer-accessible medium may include any tangible, non-transitory storage media or memory media such as electronic, magnetic, or optical media—e.g., disk or CD/DVD-ROM coupled to computer system 500 via bus 506, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 506 may be configured to coordinate I/O traffic between processor 502, system memory 504, and any peripheral devices including network interface 508 or other peripheral interfaces, connected via I/O controller(s) 510. In some embodiments, bus 506 may perform any necessary protocol, timing or other data transformations to convert data signals from one component (e.g., system memory 504) into a format suitable for use by another component (e.g., processor(s) 502A-N). In some embodiments, bus 506 may include support for devices attached through various types of peripheral buses, such as a variant of the Peripheral Component Interconnect (PCI) bus standard or the Universal Serial Bus (USB) standard, for example. In some embodiments, the operations of bus 506 may be split into two or more separate components, such as a north bridge and a south bridge, for example. In addition, in some embodiments some or all of the operations of bus 506, such as an interface to system memory 504, may be incorporated directly into processor(s) 502A-N.

Network interface 508 may be configured to allow data to be exchanged between computer system 500 and other devices, such as other computer systems attached to IP network 104, for example. In various embodiments, network interface 508 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 510 may, in some embodiments, enable connection to one or more display terminals, keyboards, keypads, touch screens, scanning devices, voice or optical recognition devices, or any other devices suitable for entering or retrieving data by one or more computer system 500. Multiple input/output devices may be present in computer system 500 or may be distributed on various nodes of computer system 500. In some embodiments, similar I/O devices may be separate from computer system 500 and may interact with computer system 500 through a wired or wireless connection, such as over network interface 508.

As shown in FIG. 5, memory 504 may include program instructions 518, configured to implement certain embodiments described herein, and data storage 520, comprising various data accessible by program instructions 518. In an embodiment, program instructions 518 may include software elements of embodiments illustrated in FIGS. 6-8. For example, program instructions 518 may be implemented in various embodiments using any desired programming language, scripting language, or combination of programming languages and/or scripting languages. Data storage 520 may include data that may be used in these embodiments such as, for example, services provisioning table 406. In other embodiments, other or different software elements and data may be included.

A person of ordinary skill in the art will appreciate that computer system 500 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

Embodiments of server 102 and clients 106a, b described in FIGS. 1 and 4 may be implemented in a computer system that is similar to computer system 500. In one embodiment, the elements described in FIG. 6 may be implemented in discrete hardware modules. Alternatively, the elements may be implemented in software-defined modules which are executable by one or more of processors 502A-N, for example.

A person of ordinary skill in the art will appreciate that computer system 500 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system or processor-based configurations.

FIG. 6 is a block diagram illustrating an example of portal application instruction modules configured to implement the hierarchical resale of telecommunication products. In an embodiment, server 102 may be configured to operate according to portal application instructions 404. In particular, processor(s) 401A-N may load and operate according to the portal application instructions as a special purpose machine.

In an embodiment, portal application instructions 404 cause server 102 to operate configure unit 602, manage unit 604, and operate unit 606. Each unit 602-606 may include one or more sub-units configured to carry out a specific set of tasks as defined by the portal application instructions 404. For example, configure unit 602 may include portal users configuration unit 608, portal access levels configuration unit 610, and portal branding configuration unit 612. In an embodiment, manage unit 604 may include a virtual storefront management unit 614, quotes management unit 616, orders management unit 618, billing management unit 620, and contacts management unit 622. In an embodiment, operate unit 606 may further include provision service unit 624, and debug services unit 626.

In an embodiment, configure unit 602 and its associated sub-units may be configured to handle portal configuration processes. For example, portal configuration processes may include setting up new users, setting portal access levels, and customizing the portal branding for each reseller. Manage unit 604 may handle receipt, fulfillment, and billing for new service orders, along with other related functions. Operate unit 606 may handle the operations aspects of providing the communication services to the customer. For example, operate unit 606 may handle configuration, provisioning and debugging of products in response to orders or customer support requests.

In an embodiment, portal users configuration unit 608 may be configured to provide an interface for allowing a system administrator to add new portal users. For example, the top level communication provider may use portal users unit 608 to set up bottom level communication provider 308a and intermediate communication providers 306a,c as users of the portal application. The setup process may include operations such as entry of account numbers, login criteria, personal information, contact information, and the like. Likewise, intermediate level communication providers 306a,c may use the portal users configuration unit 508 to add lower level portal users, such as additional intermediate level communication providers 306b, bottom level communication providers 308b,c, and/or communication services customers 310b,d, for example.

Portal access levels configuration unit 610 may be configured to provide an interface for configuring permissions with respect to various API or UI based functions of the portal application. For example, customers may be given access to place orders, view billing, view status updates, and the like. Employee users may be given access to place fulfillment orders to a higher level provider, adjust billing, create communications or acknowledgments, or the like. Additionally, permissions at each level of provider may have different access levels. In an embodiment, top level communication provider 304 may be given access to information associated with all customers and providers in the hierarchy, whereas each intermediate or bottom level partner 308, 310 may only be given access to information associated with customers and providers at a lower level or within its own provider chain. As person of ordinary skill will recognize in light of this disclosure, various other alternative portal access configurations may be used.

Portal branding configuration unit 612 may provide an interface for allowing an intermediate partner 308 or bottom level partner 310 to establish its own portal brand. For example, the color scheme, logos, copyright notices, etc. may be modified to match the individual provider's corporate brand. In some cases, however, the functional framework of the portal may remain unchanged. In a further embodiment, portal branding configuration unit 612 may provide functionality for entering server redirect information, email configuration information, such as SMTP server addresses and authentication, and the like. In such an embodiment, email and network traffic originating from the server 102 may appear as though it is originating from the client 106a,b or from the domain of the reseller.

For example, intermediate level communication provider 306a may create an authenticated email account on a proprietary email server. Intermediate level communication provider 306a may enter the server address and authentication information, such that all email traffic generated by the top level communication provider 304 from the server 102 appear as though it is originating from the intermediate level provider 306a, rather than the top level provider 304.

In still a further embodiment, branding configuration unit 612 may provide an interface where each reseller may create their own products (SKU, description, pricing, etc.) based on those provided by the top level provider. For example, the reseller may bundle one or more sets of several products provided by each respective provider into a single bundled product having a single SKU number. In such an embodiment, the resellers SKU may be mapped with the base SKU numbers of a higher level provider, and subsequently due the hierarchical model, to the products and corresponding SKUs of their supplier's supplier and so on, which may further facilitate automation of ordering and billing processes. For examples, the reseller's SKU may wrap one or more SKUs of the level above. This wrapping is taken into account for billing (i.e., reseller cost), automatic ordering (the system automatically maps reseller products to products at other levels of the reseller/customer hierarchy, when processing an order) as well as during provisioning (while SKUs, at any level, are the item provisioned against subscribers the system automatically breaks these SKUs into the root configurable/provisionable pieces to be activated and prompts the craftsperson to provide the necessary data for each). For example, if a VoIP service is wrapped and re-wrapped across two levels of resellers when it is provisioned against the user the SKU of the re-wrapped service is used but the provisioning system asks for configuration information based on the VoIP service contained within it.

Additionally, branding unit 612 may provide a template ‘terms of use’ mechanism, which permits each level to specify their branding/trademarks for application to generic terms of use document furthering the illusion that the system is not hierarchical.

In an embodiment, storefront management unit 614 may be configured to provide an interface for managing interactions with customers. For example, advertisements or promotions may be created via storefront management unit 614. Additionally, customized products may be defined, and storefront management unit 614 may generate product catalogs. Order acknowledgment and status updates may be further provided via storefront management unit 614. In an embodiment, certain actions taken by storefront management module 614 may be automated. For example, promotions may be advertised for a predetermined timeframe, and then automatically be removed or reset at the expiration of the predetermined time period. For example, orders may be tagged as ‘zero cost’ until a target date. The products in the order can be consumed at no monthly charge until the date expires at which point the items are considered as normal cost and appropriately added to the customer's monthly bill. As a matter of management the target date may be changed by the provider at any point up to the point where the target date has expired and the order is now being billed. Separately, discount levels (volume based) and special discounts (% discounts applied for products consumed by a particular customer's customer) may be applied or modified at any time having an immediate effect on future billing.

In an embodiment, quotes management unit 616 may be configured to provide a price quote to a potential communication services customer 310 in response to an inquiry. In some embodiments, quotes management unit 616 may provide an interface for allowing a live agent to enter the quote information. In another embodiment, customer 310 may be provided with a selection menu when submitting the query, and the price quote may be automatically generated in response to the selections entered by customer 310.

Orders management module 618 may be configured to receive orders for communication services from customers. In an embodiment, orders may be communicated to a live agent for handling. Alternatively, orders may be automatically forwarded up a provider chain to the top level communication provider 304 for fulfillment. Optionally, orders may be automatically accepted on a per customer basis. For example, if a reseller has a good relationship with a customer in good standing, all orders from that customer may be automatically accepted without manual intervention. Automation may be set on a per customer basis. Alternatively, all orders stop at each level to be manually accepted. In still other embodiments, orders may be communicated from the customers—e.g., communication services customers 310b,c—to top level communication provider 304. Top level communication provider 304 may then notify the intermediate level providers 306a,b and bottom level provider 308b that the order has been placed. But, in such an embodiment, top level communication provider 304 may handle fulfillment directly rather than waiting for authorization from lower level providers.

In certain embodiments, aspects of the order placement and management process may be automated. For example, forwarding of the order through the provider chain up to the top level provider 304 may be automated. In an embodiment, orders management unit 618 may allow granular control over what is automated and what requires human involvement. When automated at various levels, it may take less time to enter the initial order than it does to traverse three or four levels of administrative hierarchy, and have the order fulfilled. In a further embodiment, an order acceptance and fulfillment may be automated to bypass basic human intervention. Additionally, inventory coverage, which automatically calculates the order a reseller must make to top level provider 304 on receipt of an order from the customer, may be automated. Such an embodiment, may account for both quantities and also the conversion of reseller products to the products offered by the top level communication provider 304. Another feature which may be automated includes inventory assessment, which provides a quick snapshot view for an order management of the cost to fulfill an order from the customer.

In an embodiment, billing management unit 620 may allow providers 304-308 to bill down level customers for services provided. Certain aspects of the billing process may also be automated. For example, once services are provisioned in response to an order, billing management unit 620 may automatically generate an invoice or a billing notice requesting payment for the services. In another embodiment, billing management unit 620 may provide an interface for allowing a customer or a provider to enter the customer's billing information, such as a charge account number, banking information, or the like.

In an embodiment, contacts management unit 622 may be configured to provide an interface for allowing a provider to manage contact information for customers and potential customers. For example, contacts management unit 622 may track address, email, facsimile, telephone, website, and other contact information associated with a customer or potential customer. Additionally, contacts management module 622 may track contact information for up level providers so that the providers that are higher in the chain may be contacted for customer support, technical support, etc.

In an embodiment, services provisioning unit 624 may be configured to generate services provisioning orders 410 for server 102 to use for updating the services provisioning table 406. In an embodiment, provisioning orders may include information used for provisioning the telecommunication products to the customer, including information about the customers communication device, such as its IP address, MAC address, or the like. Additionally, provisioning data may include a list of service options that are supported/requested. Provisioning data may also include identification of a telephone number or extension number to be associated with the customer's telecommunications equipment 120-140.

Debug services unit 626 may be configured to provide information for technical support of the customer. For example, debug services unit 626 may send diagnostic signals to the customers telecommunications equipment 120-140 for ascertaining an operational state of the equipment and intermediate devices, such as router 108, VoIP gateway 110, switch 112, PBX 114, etc. Debug services unit 626 may also provide a technical support interface to a technical support technician for tracking help tickets, obtaining debug information for the network, escalating help tickets, etc.

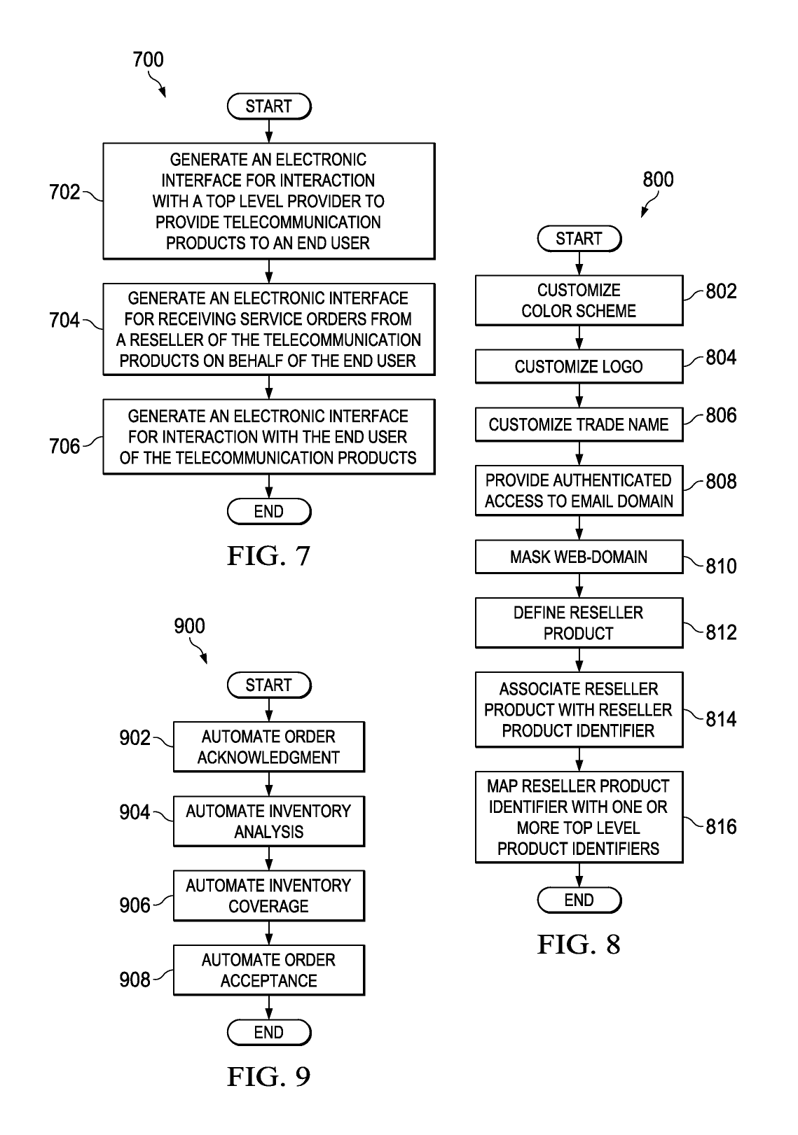

FIG. 7 is a flowchart illustrating an example of method 700 or hierarchical resale of telecommunication products. In an embodiment, method 700 starts when the server 102 generates an electronic interface for interaction with a top level provider 304 to provide telecommunication products from the carrier network 302 to a communication services customer 310a-d, as shown at block 702. At block 704, server 102 may then generate an electronic interface for receiving service orders from a reseller of the telecommunication products on behalf of the end user of the telecommunication products, for example via a web application running on client 106a. Server 102 may then generate an electronic interface for interaction with the communication services customer 310a-d, for example, at client 106b as shown at block 706.

FIG. 8 is a flowchart illustrating another example of method 800 for hierarchical resale of telecommunication products. In an embodiment, method 800 includes rebranding of the electronic interface provided for the end user. In an embodiment, rebranding may include customizing a color scheme of portal application 408 as shown at block 802. Rebranding may also include customizing a logo displayed on portal application 408 as shown at block 804. For example, the logo may be a corporate logo associated with the reseller, rather than the top level telecommunication products provider 304.

At block 806, rebranding may include customizing trade names displayed on the portal application 408. As shown at block 808, rebranding may also include providing an authenticated access to the reseller's email domain such that communications sent from top level provider 304 via portal 408 look as though they are authentically from the reseller. Additionally or alternatively, rebranding may include masking the web domain of the portal application 408 to appear as though it is hosted by the reseller as shown at block 810. Rebranding may also include defining a set of one or more reseller products. At block 812, reseller products may match one-to-one with products offered by the top level provider 304, or may be a combination or bundling of products. At block 814, reseller products may be associated with a reseller product identifier, such as a SKU number, for tracking and billing purposes. As shown at block 816, method 800 may include mapping the reseller product identifiers with one or more top level product identifiers, so that purchase orders can be fulfilled by the top level provider.

FIG. 9 is a flowchart illustrating an example of yet another method for hierarchical resale of telecommunication products. In an embodiment, the method 900 may be directed to automation of certain aspects of the telecommunication products resale model, and certain functions of the portal application 408. For example, at block 902, orders from customers may be automatically acknowledged. Acknowledgement may include a change in order status, an email notification, an automated telephone call, or the like. At block 804, server 102 may automate inventory analysis. For example, in response to receiving an order for telecommunication products, server 102 may analyze the reseller's inventory to determine whether sufficient services have been provisioned to the reseller to fulfill the purchase order from the reseller's customer. If so, the order may be automatically accepted as shown at block 908 and fulfilled. If not, an automated inventory coverage process as shown at block 906 may be employed to purchase sufficient inventory for the reseller to cover the purchase order from the customer of the reseller. As a person of ordinary skill in the art will recognize in light of this disclosure, certain of these functions the foregoing features may be fully automated, while others may only be partially automated, or not automated at all.

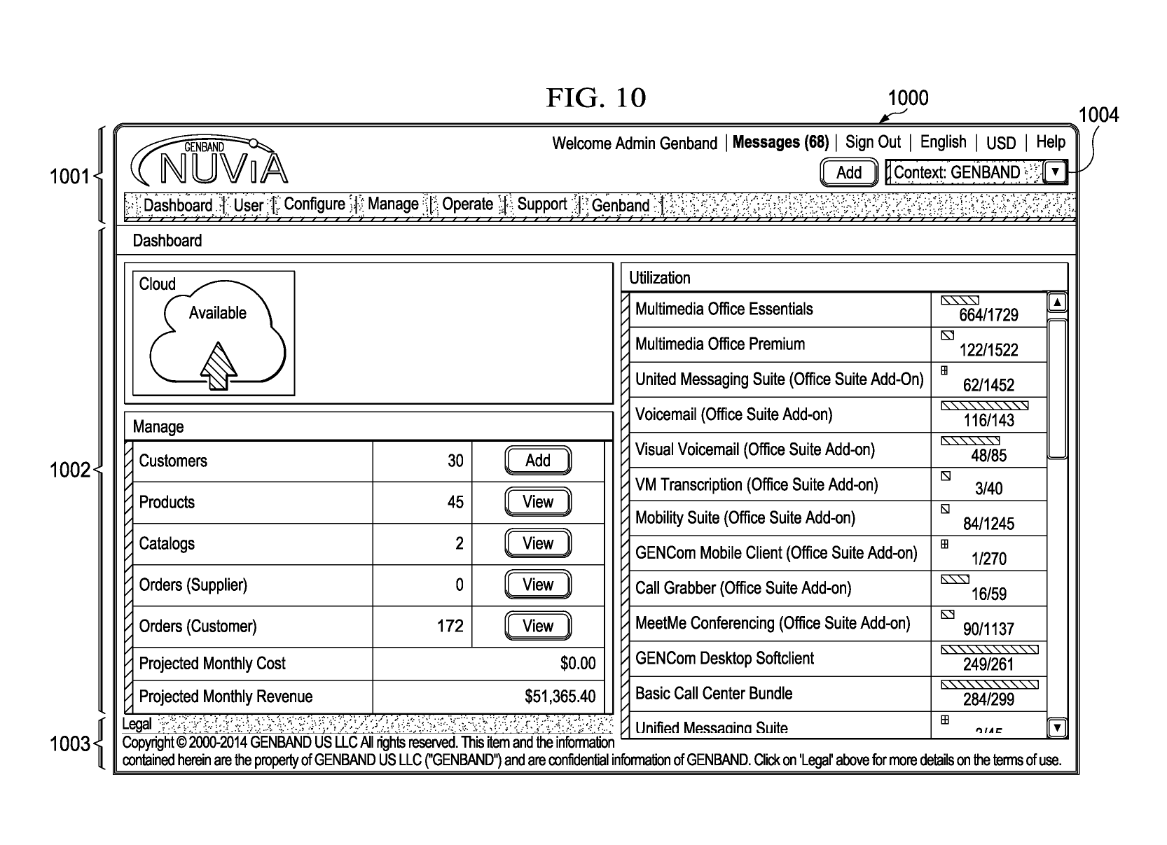

FIG. 10 shows screenshot 1000 of an example of a reseller's portal instance. In some embodiments, a computer such as computer system 500 of FIG. 5 may be configured to render screenshot 1000, for instance, within a browser window or native software application. As illustrated, top portion 1001 of screenshot 1000 displays a reseller's branding logo as well as number of selectable menu items including, but not limited to: “dashboard,” “user,” “configure,” “manage,” “operate,” “support,” etc. Top portion 1001 also includes the user's name (“Admin”) other commands or options that allow a user to view his or her messages, sign out, select a language, etc. Furthermore, top portion 1001 includes context-switching menu 1004 configured to allow a user to switch to a lower level of the portal hierarchy, as will be explained in more detail below.

Center portion 1002 of screenshot 1000 displays contents of the menu item selected in top portion 1002—in this case, “dashboard.” As such, center portion 1002 includes a cloud status notification, a manage window, and a utilization window, each of which is configured to provide a particular type of information to the user and/or allow the user to perform certain operations. Also, in this specific example, bottom portion 1003 displays a legal notice or some other disclaimer or copyright information.

In some cases, screenshot 1000 may represent an instance of the portal hierarchy accessible to an administrator user of top level provider 304 of FIG. 3—or of any entity (e.g., intermediate level provider 306c) above another entity (e.g., bottom level provider 308c) in the portal hierarchy such that the former has certain administrative privileges of the latter's portal instance. In various embodiments, one or more of these administrative privileges may include context switching and/or masquerading privileges through which a reseller can directly access a subset of portal operations in the context of their direct customers. This capability may be activated via context-switching menu 1004 to, for example, enable a reseller to assist a direct customer in provisioning products, services, etc.

Generally speaking, a user at the reseller level may configure, manage, and/or operate on behalf of their direct child consumer or customer using context switching. As such, context switching may enable a partner to manage multiple direct customers in a consistent and clear manner. In some implementations, context switching may be available only to resellers' users having sufficient permissions (e.g., account manager or administrative/operations permissions), and it may be engaged via context pull-down 1004 visible in the upper right corner of screenshot 1000.

In some embodiments, context switching may not alter permission-based access to information or controls—that is, it may not provide a way for the reseller's user to gain access to all customer information. For example, for business reasons a parent reseller may be prevented from accessing the internal operations of their child reseller or customer. Moreover, context switching may enable access to a reseller's customers that are one level down in the resale or portal hierarchy such that information about a customers' customer is not accessible.

Once context switching is properly activated, the reseller's administrative user may be capable of switching the context of his or her portal to that of one of the reseller's customers. For example, in some cases, upon switching of the portal's context, the administrative user may access the configure menu to manage a customer's users and access levels, change specific configuration parameters, view the customer specific contacts (i.e., a dedicated support contact), create orders on the customer's behalf, etc. The administrative user may also access the support menu to access the customer's support tickets, for example.

In some embodiments, permissions may be used to determine which functions and/or data the administrative user is allowed to view and/or modify. In some cases, certain menu options, functions, or parameters, may not be available to the customer. For instance, billing, quotes, and storefront information may remain private to the customer. Color cues in the menu bar and in tables help remind the reseller's administrative user that they are operating in a customer's context.

Additionally or alternatively to context switching, certain systems and methods described herein may also implement “masquerading” techniques, whereby a user may assume the identity of another user for certain purposes. In some cases, masquerading may be triggered via the same user interface mechanism that also triggers context switching (e.g., context-switching pull-down menu 1004 of FIG. 10). Nonetheless, the concept of masquerading is significantly different from context switching insofar as it allows users with appropriate permissions to assume the identity of any user of any portal instance at any time via the user interface or API. Once the target user is accepted the portal client re-loads and presents the interface, branding and all, as if the user being assumed had logged in themselves. In some cases, as a security precaution, the logging of any action performed by the masquerading user at this level may be logged as the masquerading user's true identity and not the identity of the assumed user.

At the API server level, each API call may contain both a user specific API key and a user ID, for example. Under normal operations, both API key and user ID would point to the same user. In the masquerading model, however, the API key may be that of the masquerading user and the user ID may be that of the identity being assumed. Should the server detect this variance between the two IDs, it may automatically validate the permissions of the API key user. If that user has permissions to masquerade, the server then ensures that queries and actions are executed as the assumed user (but logged as the masquerading user ID). If the API key user does not have valid permissions, then the server may deem the entire request to have been in error.

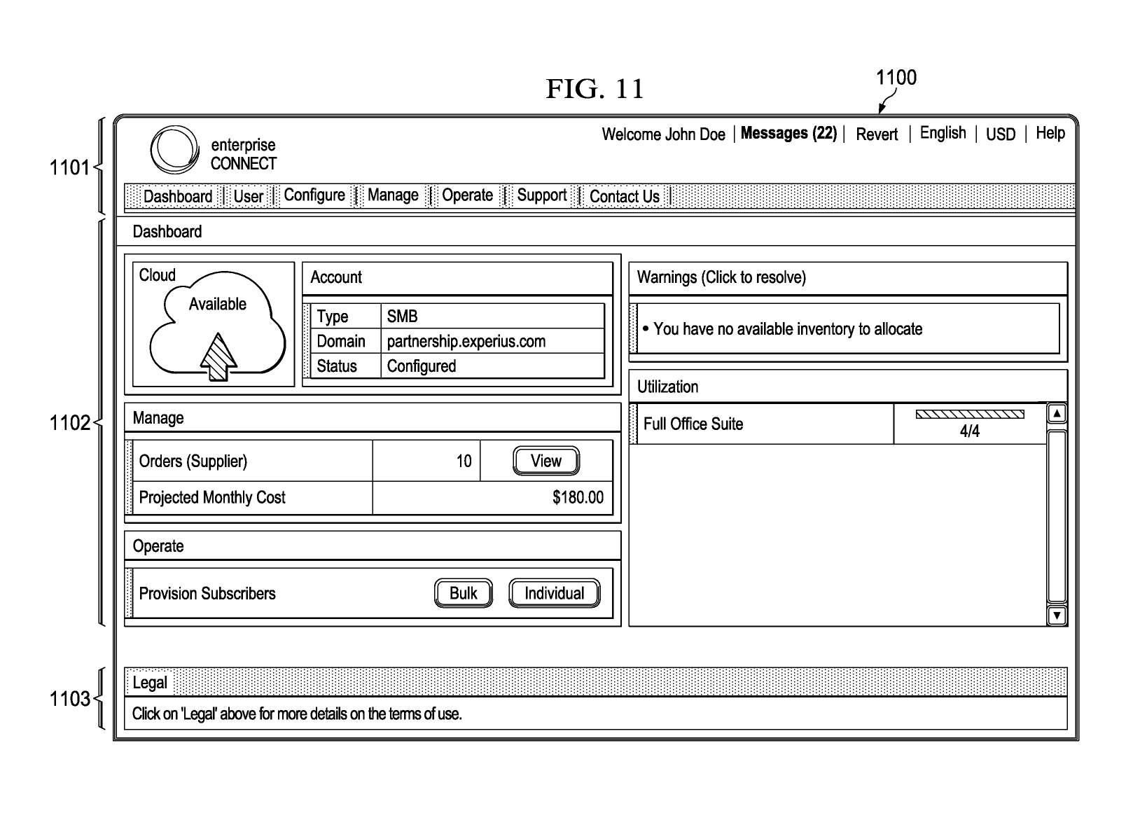

To better illustrate the foregoing, FIG. 11 shows screenshot 1100 of an example of a customer's portal instance. In some embodiments, a computer such as computer system 500 of FIG. 5 may be configured to render screenshot 1100, for instance, within a browser window or native software application. As depicted, top portion 1101 of screenshot 1000 displays a customer's brand or logo, the masqueraded user's name (“Welcome Ted Stuchberry”), as well as a number of selectable menu items similar to those in FIG. 10. In contrast with the interface shown in FIG. 10, however, top portion 1101 does not have a context-switching menu.

Center portion 1102 of screenshot 1100 displays contents of the “dashboard” menu item selected in top portion 1102, and it includes a cloud status notification, an account window, a manage window, an operate window, a warning window, and a utilization window, each of which providing a particular type of information to the user and/or allow the user to perform certain operations. Meanwhile, bottom portion 1103 displays a legal notice or some other disclaimer or copyright information, which is different from the legal notice in FIG. 10.

As previously noted, in some embodiments screenshot 1100 may include visual features that are distinct from those of screenshot 1000 to facilitate the user's recognition of which context is being used. For example, the entity's logo, color scheme, window arrangement, etc. may be different between the portal instances of screenshots 1000 and 1100.

Still referring to FIGS. 10 and 11, in some embodiments users with appropriate permissions may be allowed to assume the identity of any user of any portal instance at any time via the user interface or API. Once the target user is accepted, the portal client re-loads and presents the interface, branding and all, as if the user being assumed had logged in themselves. As a security precaution, the logging of any action performed by the masquerading user at this level may be recorded as the masquerading user's true identity, rather than that of the assumed user.

At the API server level, each API call may contain both a user specific API or authentication key (e.g., “23SFSDF234SDFKJ3135FLK4KPPOEKJ59”) and a user ID (e.g., “user1”). In normal operation, both the authentication key and the user ID point to the same user. In masquerading mode, however, the API key may be that of the masquerading user and the user ID may be that of the identity being assumed. When the server (e.g., server 102 in FIG. 4) receives an API call and detects a variance between the two different forms of identification, it automatically validates the permissions of the API key user. If the API key user has permissions to masquerade, then the server ensures that queries and actions are executed as the assumed user indicated in the user ID but logged as API key user. If the API key user does not have valid permissions then the entire request is deemed to be in error.

For sake of illustration, an example of a request message is depicted below:

GET /server/path
[Header]
Userid: user1
Authentication Key: 23SFSDF234SDFKJ3135FLK4KPPOEKJ59
[Body]
<Data>

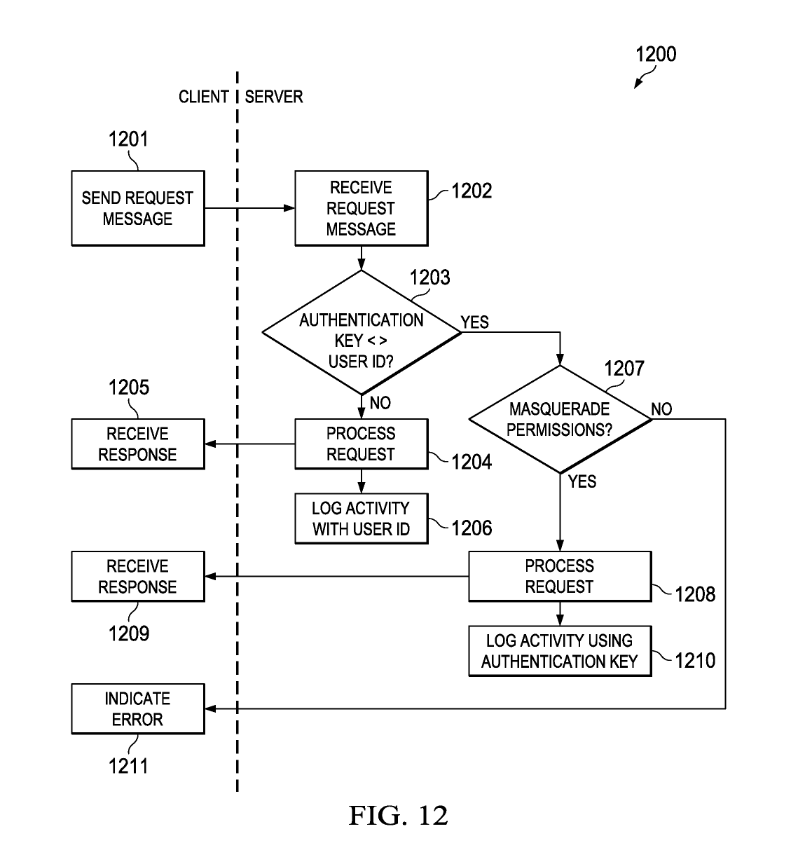

Actions performed by the server upon receiving such a request message may be described by the pseudo code that follows, which is explained in more detail in connection with FIG. 12:

AuthUser = Get user associated with Authentication Key.
If (AuthUser does not equal Userid) then

If(AuthUser has permissions to masquerade) then

Proceed with request in the context of Userid but log
actions as AuthUser

Else

Error (Request Denied)

EndIf

Else

Proceed with request in the context of Userid and log actions as same

EndIf

FIG. 12 is a flowchart illustrating an example of method 1200 for portal context switching and user masquerading. In some embodiments, certain operations of method 1200 may be performed by a client device (e.g., clients 106a,b) and others may be performed by a service (e.g., server 102), as indicated by the dotted line. At block 1201, the client device may send a request message to the server, for example, to query or enact a change to a given portal instance via a web client (or native application) using an Application Programming Interface (API) call, where the API call includes an API or authentication key as well as a user identifier or ID. At block 1202, the server may receive the API call and may inspect its header.

At block 1203, if the server determines that the authentication key and the user ID of the request's header match each other, it may process the request 1204 as an ordinary request, and may provide a corresponding response to the client at block 1205. In this scenario, the request and other activities performed by the user may be recoded by server 1202 under the user ID which, incidentally, points to the same user as the authentication key.

If the authentication key is different from the user ID, as determined by block 1203, the server may identify the request as a masquerading attempt. In that case, the server determines at block 1207 whether the authentication key has masquerading permissions.

If the user associated with the authentication key has masquerading permissions, block 1208 may process the request by switching the context of the portal instance to that of the user associated with the user ID, and the server may then provide an appropriate response to the client at block 1209, which may include context switching. Particularly, to fulfill the context switching, the server may make a given feature visible to the user through the portal instance, where the feature would otherwise be visible only to those users belonging to the same organization as the user identified in the user ID. Moreover, the server may log the request and/or other associated user activity as having been performed by the user associated with the authentication key, rather than the user ID, at block 1210.

Conversely, if the authentication key is not associated with authentication permissions at block 1207, then the server may provide an error message or the like to the client at block 1211. This procedure may serve to prevent the user corresponding to the authentication key from assuming an identity of the other user associated with the user ID.

Although certain embodiments are described herein with reference to specific examples, numerous modifications and changes may be made in light of the foregoing description. Accordingly, the specification and figures are to be regarded in an illustrative rather than a restrictive sense, and all such modifications are intended to be included within their scope. Any benefits, advantages, or solutions to problems that are described herein with regard to specific embodiments are not to be construed as a critical, required, or essential feature or element of any or all the claims. Furthermore, it should be understood that the various operations described herein may be implemented in software, hardware, or a combination thereof. The order in which each operation of a given technique is performed may be changed, and the elements of the systems illustrated herein may be added, reordered, combined, omitted, modified, etc. It is intended that the embodiments described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The term “coupled” is defined as “connected” and/or “in communication with,” although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
making available, via one or more computer systems, a plurality of portal instances having a hierarchical structure of resellers and customers of communication services, each of the plurality of portal instances having a plurality of users, each of the plurality of users associated with a corresponding one of a plurality of different access levels, a given access level configured to determine a feature that is visible to a given user through a given portal instance; and
allowing the given user to query or enact a change to the given portal instance via a web client using an Application Programming Interface (API) call, wherein the API call includes an API key and a user identifier.

2. The method of claim 1, wherein the API key and the user identifier both point to the given user, and wherein the given portal instance is associated with a reseller or customer organization to which the given user belongs.

3. The method of claim 1, wherein the API key points to the given user, the user identifier points to another user, the given user belongs to a first organization, and the other user belongs to a second organization that is lower in the hierarchical structure than the first organization.

4. The method of claim 3, herein the second organization is a customer of the first organization.

5. The method of claim 3, further comprising identifying a masquerading attempt on the part of the given user based, at least in part, upon the API key and the user identifier pointing to different users.

6. The method of claim 5, further comprising stopping the given user from assuming an identity of the other user in response to the API key not indicating a masquerading privilege.

7. The method of claim 5, further comprising allowing the given user to assume an identity of the other user in response to the API key indicating a masquerading privilege.

8. The method of claim 7, further comprising making a given feature visible to the given user through the given portal instance, wherein the given feature would otherwise be visible only to yet another user belonging to the same organization as the other user.

9. The method of claim 7, further comprising logging one or more actions or events caused by the given user using an identity of the given user derived from the API key.

10. A tangible computer-readable storage medium having program instructions stored thereon that, upon execution by a computer system, cause the computer system to:
receive an Application Programming Interface (API) call from a user, wherein the API call includes at least two distinct user identifiers; and
provide at least one portion of a portal instance to the user in response to the API call, wherein the portal instance is one of a plurality of portal instances associated with different organizations arranged in a hierarchical structure.

11. The tangible computer-readable storage medium of claim 10, wherein the at least two distinct user identifiers include a key and an identity.

12. The tangible computer-readable storage medium of claim 11, wherein the key points to the user, the identity points to another user, the user belongs to a first organization, and the other user belongs to a second organization that is lower in the hierarchical structure than the first organization.

13. The tangible computer-readable storage medium of claim 12, herein the second organization is a customer of the first organization.

14. The tangible computer-readable storage medium of claim 12, wherein the program instructions, upon execution by the computer system, further cause the computer system to identify a masquerading attempt on the part of the user.

15. The tangible computer-readable storage medium of claim 14, wherein the program instructions, upon execution by the computer system, further cause the computer system to allow the user to assume an identity of the other user.

16. The tangible computer-readable storage medium of claim 15, wherein the at least one portion of a portal instance provided to the user is ordinarily provided to the other user and includes one or more features associated with the second organization.

17. A computer system, comprising:
a processor; and
a memory coupled to the processor, the memory including program instructions stored thereon that, upon execution by the computer system, cause the computer system to:
receive a command from a user to query or enact a change to at least one portion of a portal instance hosted by a server, wherein the portal instance is one of a plurality of portal instances associated with different organizations arranged in a hierarchical structure;
transmit an Application Programming Interface (API) call to the server, wherein the API call includes an API key and a user identifier; and
receive a response to the API call from the server.

18. The computer system of claim 17, wherein the API key points to the user, the user identifier points to another user, the user belongs to a first organization, and the other user belongs to a second organization that is lower in the hierarchical structure than the first organization.

19. The computer system of claim 18, wherein the server is configured to allow the user to assume an identity of the other user in response to the API key indicating masquerading privileges.

20. The computer system of claim 19, wherein the program instructions, upon execution by the computer system, further cause the computer system to render an aspect of the response to the user, wherein the aspect includes a visual feature associated with the second organization and not associated with the first organization.
